(19) United States
(12) Patent Application Publication
(10) Pub. No.: US 2025/0250805 A1
(43) Pub. Date: Aug. 7, 2025

(54) SAFETY DEVICE FOR A LIFTING APPARATUS, LIFTING APPARATUS, LIFTING SYSTEM AND CORRESPONDING SAFETY CONTROL METHOD

(71) Applicant: ELECTROELSA SRL, Casole d'Elsa (IT)

(72) Inventor: Giorgio TALIANI, Poggibonsi (IT)

(21) Appl. No.: 18/856,096

(22) PCT Filed: Apr. 13, 2023
(86) PCT No.: PCT/EP2023/059699

§ 371 Date: Oct. 11, 2024

(30) Foreign Application Priority Data
Apr. 13, 2022 (EP) 22425019.1

(51) Int. Cl. E04G 5/00; B66B 5/02; B66B 9/02; B66B 9/187; B66F 17/00; E04G 3/28

(52) U.S. Cl. CPC E04G 5/001; B66B 5/02; B66B 9/022; B66B 9/187; B66F 17/006; E04G 3/28; E04G 2003/286

(57) ABSTRACT

A safety device is described that can be used on a column or a segment of a column which functions as a support of a lifting apparatus, such as a goods hoist or an elevator or a work platform, used on a construction site. Furthermore, the safety device can be used in combination with the lifting apparatus mounted on the column or the segment of a column. In addition, the safety device can be used in all vertical constructions that are modularly mounted from the bottom upward.

### FIELD OF THE INVENTION

The embodiments described here concern a safety device for a lifting apparatus, a lifting apparatus and corresponding safety control method.

The safety device can be used on a column or a segment of column that functions as a support for a lifting apparatus, such as a goods hoist or elevator or work platform, used on a construction site.

Furthermore, the safety device can be used in combination with said lifting apparatus mounted on said column or said segment of column.

In addition, the safety device can be used in all those vertical constructions that are modularly mounted from the bottom upward.

The lifting apparatus can be used in construction sites, shipyards, civil engineering yards, and in all yards where there is a need to build to considerable heights and wherever it is necessary to use lifting means for transporting objects and/or people.

The lifting apparatus can also be used in emergency situations, where it is necessary to quickly prepare a lifting system that allows the vertical movement of objects and/or people.

The safety device and lifting apparatus can be used on any vertical structure that is part of a system for lifting objects and/or people.

The safety device and lifting apparatus can be used whenever there is a need to verify the stability of a bearing column to support a system for lifting objects and/or people.

The method can be used during the installation and/or disassembly of a vertical structure to support a system for lifting objects and/or people.

The method can be used to verify the stability of a bearing column supporting a system for lifting objects and/or people.

### BACKGROUND OF THE INVENTION

It is known that in recent decades the world of construction and/or maintenance has seen a considerable development in the construction of buildings or structures that reach considerable heights, from several tens up to several hundred meters.

The construction or maintenance of buildings or structures that reach such heights has created the need to develop new systems for lifting objects and/or people, mainly used on sites during construction or maintenance.

Usually, these lifting systems consist of a bearing column having a rack on which a basket, equipped with a motor and pinion which is coupled to the rack of the bearing column, ascends.

To facilitate the installation of these lifting systems, modular columns have been developed. As soon as the first column module is installed, the assembly of said lifting systems proceeds with the installation of a subsequent column module which is added on top of the last column module already mounted and firmly attached to the rest of the column and/or the support structure. The installation continues, repeating this action of adding a column module above the last column module already mounted and attached, until the desired height is reached.

To overcome the problem that the lifting apparatus might continue its travel beyond the last column mounted, thus causing the uncoupling of the lifting apparatus, and the load support device connected to it, from the column itself and therefore causing it to fall to the ground, locking systems of the motor of the lifting apparatus are known, which detect the absence of the column and open a contact connected with the electric motor of the apparatus, causing it to stop.

The load support device or containing element is a cabin in the case of construction site elevators, an open basket in the case of hoists and a platform in the case of a work platform.

These lifting apparatuses are mostly used temporarily, such as on construction sites, so they can undergo frequent assembly or disassembly to reposition them elsewhere on the same site or on other sites.

The great frequency of assembly or disassembly of such lifting systems can affect overall safety, since there is a greater probability that the column will not be assembled or secured correctly, due to human error or carelessness.

Document DE-A1-4447424 discloses a safety device provided with an arm maintained into pressure contact, by means of a spring device, on a mast on which a goods hoist, with a force which provokes the overturn of a mast section if it is not fixed. The arm is kept into pressure contact by means of a driver member of the thruster type. Such document therefore fails to describe a driver member configured to exert a traction force on the arm of the safety device. Moreover, the described device does not comprise any block element suitable to block a mast which would have been overturned. It is also observed that the device of this document comprises a unique thrust arm, which makes it suitable only for masts having a rectangular triangle section. With masts having a different section, a single pressure point implies the risk of an undesired rotation of the overturned mast, and of a consequent fall thereof.

Documents US-A-3232382 and AT-B-382592 describe goods hoists of the known type which have, as a container element, a basket, a cabin or a platform. Such documents do not disclose any safety device to check that a module of a mast is correctly screwed to the modules below.

One disadvantage of the state of the art is that it is not possible to verify whether the individual modules of the bearing column are correctly mounted and attached, in particular the last module mounted, that is, the highest one.

Another disadvantage of the state of the art is that, if the last module of the column is not well attached to the other modules of the column, once the lifting apparatus is in correspondence with said module, the latter can detach from the rest of the column, causing the lifting apparatus to fall.

In this case, any object and/or person present in the cabin, in the basket or on the platform of the lifting apparatus also falls (together with the lifting apparatus itself) causing damage to the objects present in the load support device, damage to objects or people on the ground in the zones surrounding the basket, or, more seriously, traumas of varying importance or even death to the people transported at the time of the fall.

Another disadvantage of the state of the art is that it is impossible to verify the correct assembly of a module of the bearing column during the assembly or disassembly of the lifting system.

Yet another disadvantage of the state of the art is the reduced safety in the use of the lifting apparatus during assembly, disassembly, or operational use of the lifting system.

In particular, one purpose of the present invention is to provide a safety device which allows to verify the correct assembly of the bearing column.

Another purpose of the present invention is to provide a safety device which allows to verify the presence of the last module of the bearing column and, therefore, before the lifting apparatus reaches it.

Another purpose of the present invention is to provide a safety device which allows to prevent the lifting apparatus from falling.

Another purpose of the present invention is to provide a safety device which allows to determine the correct assembly of the bearing column when the lifting system is mounted.

Another purpose of the present invention is to provide a safety device that allows to increase safety in the use of a lifting apparatus during assembly, disassembly, or operating use of the lifting system.

Further purposes of the present invention are to provide a safety device, a lifting apparatus, a lifting system and a method for assembly, disassembly, and use of a lifting system which allow to overcome the disadvantages of the state of the art as described above.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the embodiments described here concern a safety device comprising a support element and at least one safety element integral with the support element.

The at least one safety element comprises a sustaining element, a traction element mechanically connected to the sustaining element in such a way as to allow a movement of the traction element, and a command element configured to open an electrical safety contact when the traction element moves with respect to a predetermined position.

The safety device also comprises a driver element connected at one end thereof with the traction element and configured to exert a traction force on the traction element toward the sustaining element. Such a driver element, of the traction type, allows to have an increase robustness of the safety device, which makes it suitable to be used also in goods hoists having high loads, or loads that are higher with respect to the disclosure of DE-A1-4447424.

In one example of the invention, the driver element is connected at its other end to the sustaining element.

In yet another example of the invention, the traction element comprises at one end thereof, distal with respect to the sustaining element, a contact protrusion configured to transmit the traction force generated by the driver element and having a sliding surface facing toward the sustaining element.

In accordance with embodiments of the invention, the safety device comprises two safety elements that each contain a respective traction element, configured to exert a traction on two different points of a bearing column. Both the traction elements are advantageously connected to the same sustaining element. In an advantageous way, both the safety elements are reciprocally distanced so that each traction element exerts a traction on a respective pillar of a same module of the bearing column, preferably at a same height. Doing so, possible undesired rotations of the module are avoided, in case it is overturned. Advantageously, each traction element is equipped with a respective driver element, preferably of the type configured to exert a traction force on the element towards the sustaining element.

Furthermore, according to another aspect of the invention, the safety device comprises a first locking element which protrudes from an upper end of the sustaining element.

In another example of the invention, the safety device comprises a second locking element in correspondence with a lower end of the sustaining element.

In another example of the invention, the driver element is a spring or an elastic element or a weight.

In another example of the invention, the command element is selected from a single pole switch, a limit switch, or a current diverter.

Furthermore, according to another aspect of the invention, a lifting apparatus is created which comprises a motor element equipped with at least one electric motor and a pinion driven by the electric motor and configured to be coupled to a rack; and a containing element configured to contain people and/or objects and connected to the motor element. The lifting apparatus also comprises a safety device as described above.

In one example of the invention, the containing element is a cabin, a basket or a platform.

Furthermore, another aspect of the invention provides a lifting system comprising at least one substantially vertical bearing column and comprising a plurality of modules, wherein each module comprises at least three pillars wherein at least one of the plurality of pillars comprises a rack, or the rack is attached on the column.

The modules stack perfectly in such a way that each pillar of each module is perfectly overlapping along the vertical with an associated pillar of the module below.

The lifting system comprises a lifting apparatus, wherein the pinion of the motor element couples to the rack in order to allow the movement of the movement apparatus, and wherein the sliding surface of the traction element is in contact with a pillar which is located in an intermediate position between the sliding surface and the sustaining element of the safety device, in such a way as to allow the traction element to exert a constant traction on the module.

In one example of the invention, the command element defines an electrical safety contact that allows the electrical connection between the electric motor of the motor element and an electrical power supply.

In another example of the invention, the command element is configured to open the electrical safety contact when it detects a displacement of the traction element, thus preventing the power supply of the electric motor.

In another example of the invention, the lifting system comprises a plurality of bearing columns and the lifting apparatus comprises a plurality of safety elements, wherein each safety element is associated with a respective column of the plurality of columns.

In another example of the invention, when the command element of at least one column of the plurality of columns determines a displacement of the traction element, the lifting system is configured to stop the electric power supply of all the electric motors.

In another aspect of the invention, there is provided a safety control method of a lifting system, which comprises the following steps:
supplying at least one bearing column, each one comprising at least one first module;
mounting the lifting apparatus on the first module;
moving the lifting apparatus until the at least one traction element goes beyond an upper end of the first module;
determining, by means of the command element, whether a second module is mounted on the first module and, if it is mounted, whether it moves under the action of a traction force exerted by the traction element;
stopping, by means of the command element, the power supply of the electric motor of the lifting apparatus when it is determined that the second module is not present or, if present, whether it moves under the action of the traction element.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 shows a lateral view of a lifting system;

FIG. 2 is a lateral view of a safety device according to an example of the present invention;

FIG. 3 shows a three-dimensional view of a safety device according to one example of the present invention;

FIG. 4 shows a three-dimensional view of a safety device according to one example of the present invention;

FIG. 5 shows a lateral view of a safety device mounted on a lifting apparatus in three successive phases during use; and

FIG. 6 shows a block diagram containing successive steps of a safety control method of a lifting system.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

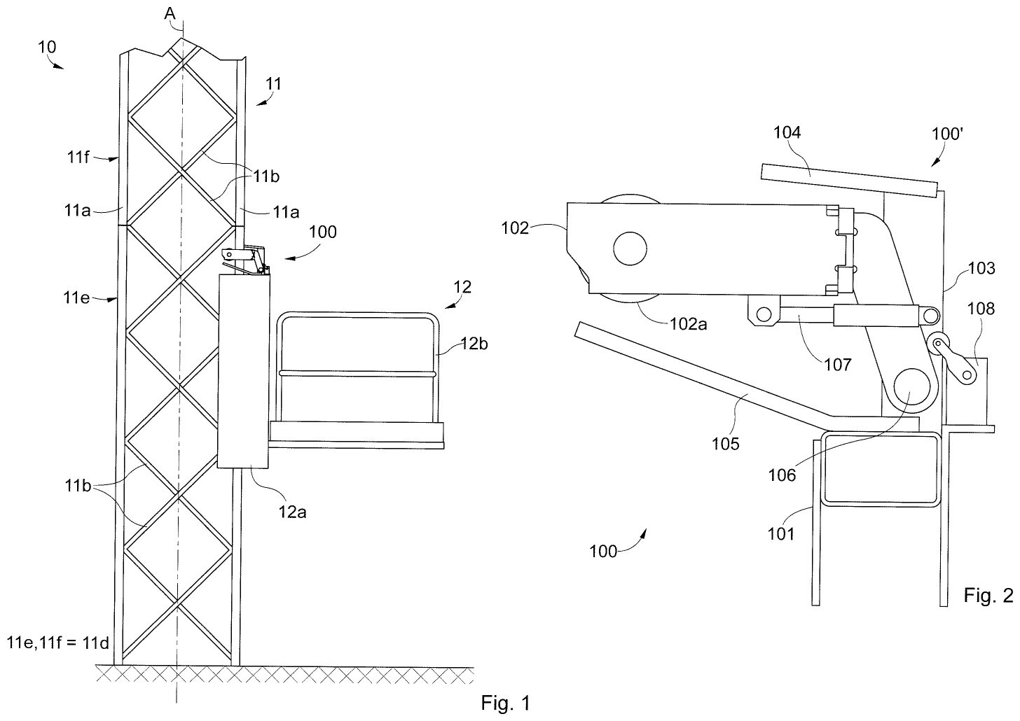

With reference to FIG. 1, a lifting system 10 comprises a bearing column 11 which defines an axis A, usually the vertical axis or a substantially vertical axis. The bearing column 11 consists of a plurality of modules 11d the same as each other and with a polygonal section along a plane perpendicular to the axis A, wherein the polygon associated with such section comprises at least three vertices, each one corresponding to the position of a pillar 11a of the bearing column 11.

The modules 11d stack perfectly, in such a way that each pillar 11a of each module 11d is perfectly overlapping and aligned along the vertical with an associated pillar 11a of the module 11d below and of the module 11d above.

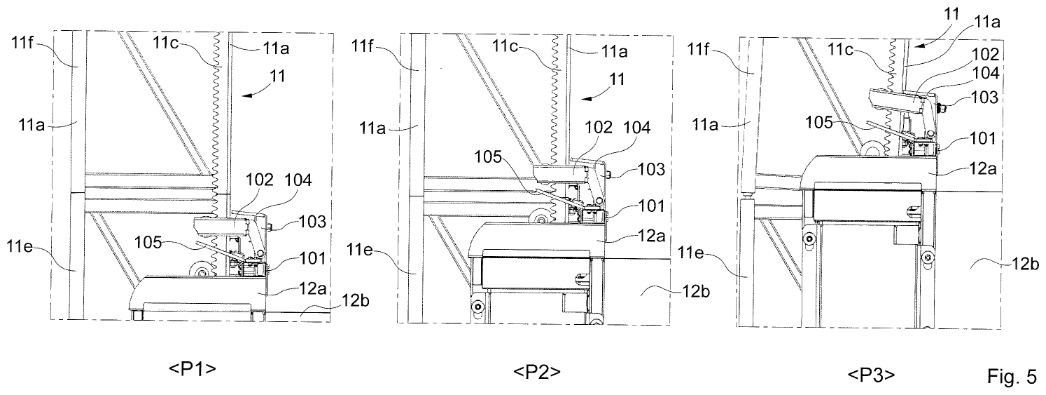

The pillars 11a of each module 11d are connected two by two by means of tie rods 11b, and each module 11d comprises a rack 11c (shown in FIG. 5).

The rack 11c can be positioned in correspondence with a pillar 11a or in an intermediate position between two pillars 11a.

Each module 11d is made integral with a module 11d below by means of attachment means such as screws, bolts, or suchlike located at the ends of each module in correspondence with each pillar 11a.

A plurality of stacked and integral modules 11d form the bearing column 11 which has a number of pillars 11a equal to the number of pillars 11a of each single module 11d.

Although the drawings show a triangular-based bearing column 11, the person of skill in the art will understand that this is a non-limiting example of the invention and that what described here can be applied to bearing columns that have a polygonal base different to the triangular one.

The person of skill in the art will understand that the invention also concerns a column 11 consisting of only two pillars 11a connected to each other by tie rods 11b and which are then attached along a bearing wall or structure.

Ultimately, the person of skill in the art will understand that the invention concerns a bearing column 11 comprising at least two pillars 11a.

The lifting system 10 also comprises a lifting apparatus 12 having at least one motor element 12a which comprises a motor (not shown in the drawings) and a pinion (not shown in the drawings) which is configured to couple to the rack 11c in order to allow the movement of the lifting apparatus 12 along the axis A.

The lifting apparatus 12 also comprises a containing element 12b, for example a basket, a cabin or a platform, configured to contain and/or transport people and/or objects. The containing element 108 can also be defined as a load support device.

Thanks to the propulsion of the motor, usually an electric motor, and to the coupling between the pinion and the rack 11c, the lifting apparatus 12 can be moved along the axis A in both senses. This allows to lift or lower people and/or objects contained in the containing element 12b.

The lifting apparatus 12 also comprises a safety device 100 integral therewith. The safety device 100 is configured to lock the motor of the lifting apparatus 12 in the event that a status of incorrect assembly of a module 11d of the bearing column 11 is determined, in particular in the event that a module 11d is not correctly attached to the module 11d below or in the event that a module 11d is missing.

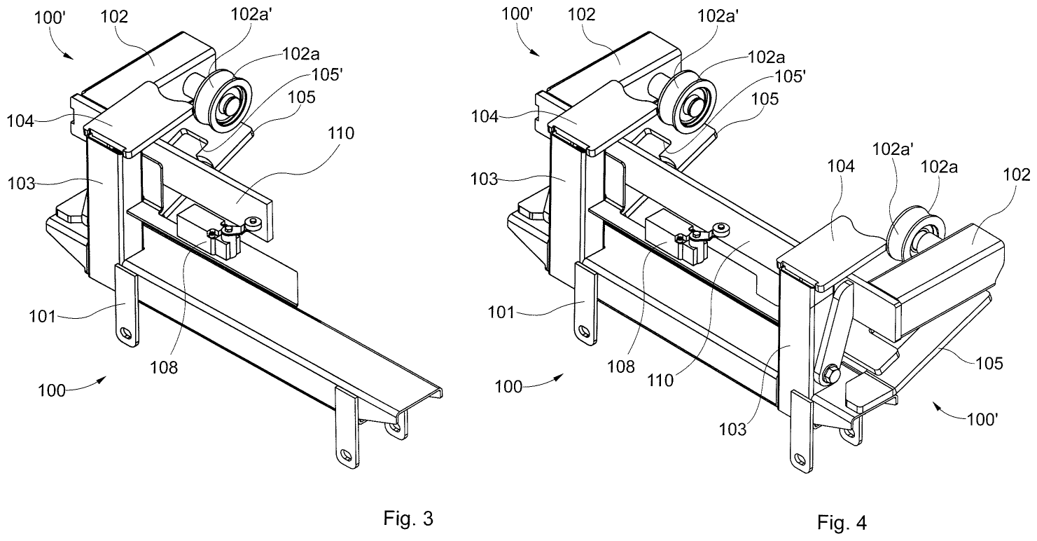

With reference to FIGS. 2 and 3, the safety device 100 includes a support element 101 configured to be attached to the lifting apparatus 12 and a safety element 100′ mounted integral therewith.

The safety element 100′ comprises a sustaining element 103 attached in a non-removable manner to the support element 101 and a traction element 102 mechanically connected to the sustaining element 103. In the embodiment shown in the drawings, the traction element 102 is connected rotatable with respect to the sustaining element 103.

The support element 101 and the sustaining element 103 can also be built as a single piece.

The support element 101 is configured to allow a rigid mechanical connection to the lifting apparatus 12 by means of attachment means, such as screws, bolts, and suchlike, not shown in the drawings, or by means of a pressure interlocking with a mating part present on the lifting apparatus 12.

Optionally, the safety device 100 is attached to the lifting apparatus 12 by means of a welding between the support element 101 and the mating part present on the lifting apparatus 12.

The safety device can be attached both to the motor element 12a and also to the containing element 12b of the lifting apparatus 12.

The sustaining element 103 is attached to the support element 101 in such a way that relative movements between the sustaining element 103 and the support element 101 are not possible. In other words, the lifting apparatus 12 and the safety device 100 form a single block when the safety device 100 is mounted on the lifting apparatus 12.

The traction element 102 is mechanically connected to the sustaining element 103 by means of a joint element 106 such as a hinge, a mobile joint, a through screw, a bolt and suchlike. The joint element 106 is configured to allow the relative movement between the traction element 102 and the sustaining element 103.

A driver element 107 is mechanically connected with a first end thereof to the traction element 102 and with its second end to the sustaining element 103. The driver element 107 is configured to exert a force on the traction element 102 directed toward the sustaining element 103. In other words, the driver element 107 is configured to make the traction element 102 move toward the sustaining element 103. The driver element 107 can be a spring, an elastic mean, an electric actuator, a pneumatic or hydraulic actuator and suchlike. The person of skill in the art will understand that the driver element 107 is not limited to the previous examples and that any mechanism whatsoever capable of exerting a traction on the traction element 102 that makes it move toward the sustaining element 103 can be used in the present invention.

The person of skill in the art will understand that the position of the driver element 107 is not limited to the position shown in FIG. 2.

If no external force is applied to the traction element 102, except for the force exerted by the driver element 107, the traction element 102 moves toward the sustaining element 103 under the effect of the traction force of the driver element 107. On the contrary, when an external force is exerted on the traction element 102 and when this force has the opposite sense with respect to the sense of the force generated by the driver element 107, and modulus greater than it, the traction element 102 moves away from the sustaining element 103.

A position of maximum opening corresponds to a predetermined position of the driver element 107 in the operating configuration. The position of maximum opening corresponds to the position of the traction element 102 when the safety device 100 is mounted on the lifting apparatus 12, which is in turn mounted on a correctly mounted module 11d of a column 11.

The traction element 102 also comprises a contact protrusion 102a, protruding from one end of the traction element 102 which is located in a distal position with respect to the sustaining element 103. The contact protrusion 102a comprises a sliding surface 102a′ (FIG. 3) facing toward the sustaining element 103 and configured to slide along a surface, for example the surface of the pillar 11a of the bearing column 11 of a lifting system 10.

In one example of the invention, the sliding surface 102a′ is the external surface of a wheel free to rotate around its main axis, the wheel being part of the contact protrusion 102a. In the embodiment shown, the wheel comprises a peripheral groove, corresponding to the sliding surface 102a′ configured to engage in a respective pillar 11a, which generally has a circular section. The person of skill in the art will understand that the invention is not limited to pillars 11a that have a circular section but that it can equally be used with pillars with a rectangular or square section.

A command element 108 is installed on the safety device 100 in contact with the traction element 102 or any other element integral with the traction element 102. For example, in FIG. 2, the command element 108 is located in direct contact with the traction element 102, while in the example shown in FIG. 3 the command element 108 is located in contact with a connection element 110 integral with the traction element 102 and which extends in an orthogonal direction with respect to a plane on which the traction force generated by the driver element 107 acts.

The command element 108 is configured to allow the opening or closing of an electrical safety contact, that is, to prevent or allow, respectively, the passage of an electric current inside a circuit. The command element 108 is configured in such a way as to allow the passage of a current, that is, to close an electrical safety contact, when the traction element 102 is in the position of maximum opening.

The command element 108 is also configured in such a way as to open an electrical safety contact, that is, to prevent the passage of a current, as soon as the traction element 102 leaves the position of maximum opening, that is, when the traction element 102 moves toward the sustaining element 103.

In other words, the command element 108 acts as a limit switch which opens a contact as soon as the position of the traction element 102 differs from the position of maximum opening.

The command element 108 can be any switch whatsoever, such as a single pole switch, a limit switch, a current diverter and suchlike. Such switches can be defined as safety switches when certified as safety components.

The person of skill in the art will understand that any other type of switch that is configured to open a contact as soon as the traction element 102 leaves the opening position can be used, without this compromising the scope of protection of the invention.

During use, the safety device 100 is mounted on the lifting apparatus 12. More in detail, the safety device 100 is mounted on the lifting apparatus 12 in such a way that the contact protrusion 102a of the traction element 102 is located in a higher position with respect to the pinion of the motor element 12a of the lifting apparatus 12. We have verified that the safety device 100 has greater efficiency when the traction element 102 exerts its force on the module 11d at a distance comprised between 10 and 50 cm from the support element 101.

During use, the safety element 100 is mounted in such a way that the sliding surface 102a′ is in contact with the surface of a pillar 11a of the bearing column 11. In other words, when the safety device 100 is in use, a pillar 11a of the bearing column 11 is located in an intermediate position between the sliding surface 102a′ and the sustaining element 103, always remaining in contact with the sliding surface 102a′.

In this condition, the driver element 107 exerts a force on the traction element 102 which transfers the force received to the pillar 11a of the bearing column 11.

The person of skill in the art will understand that the invention is not limited to a sliding surface 102a′ which engages on a pillar 11a, but that it can comprise a sliding surface 102a′ which engages with a rack 11c. In one example of the invention, the sliding surface 102a′ of the traction element 102 is a gear (not shown in the drawings) which couples to the rack 11c in such a way as to allow the traction element 102 to exert a constant traction on the module 11d and therefore on the bearing column 11 through the rack 11c. The presence of a gear as the sliding surface 102a′ allows the traction element 102 to not change its position of maximum opening during the movement of the lifting apparatus 12 along the bearing column 11.

In summary, in the rest of the description we will refer to a contact between the contact surface 102a′ and the pillar 11a. The person of skill in the art will understand that the same description of the invention reported below also applies when the sliding surface 102a′, being a gear, acts on the rack 11c instead of on the pillar 11a.

Each module 11d of the bearing column 11 is attached to a module below by means of attachment means, screws, bolts and suchlike, located in correspondence with each of the at least three pillars 11a.

When the lifting apparatus 12 travels along the bearing column 11, for example when it rises along the bearing column 11, the traction element 102 continuously exerts a pulling force on the associated pillar 11a (position P1 of FIG. 5). When the traction element 102 acts on the rack 11c, the traction element 102 continuously exerts a pulling force on the rack 11c.

At the beginning of the motion, the lifting apparatus 12 is located on a first module 11e, on which the traction element 102 exerts the traction force generated by the driver element 107.

During the motion of the lifting apparatus 12, there will be a situation in which the traction element 102 is located at a higher level with respect to an upper end of the first module 11e. In this case, the traction element 102 exerts a force on a second module 11f located at a higher height with respect to the first module 11e which bears the weight of the lifting apparatus 12 (position P2 of FIG. 5). The module 11e is the module 11d directly below the second module 11f and on which the second module 11f has to be attached for a correct mounting of the bearing column 11.

In this case, if the second module 11f, on which the traction element 102 exerts a force, is not correctly attached to the first module 11e, in correspondence with which the pinion of the motor element 12a is located, the force exerted by the traction element 102 causes the second module 11f to be moved in the sense of the force generated by the driver element 107, that is, toward the sustaining element 103 (position P3 of FIG. 5).

Consequently, the traction element 102 will move and leave the position of maximum opening, causing the drive of the command element 108 which, consequently, will open an electrical safety contact.

On the other hand, when the second module 11f is not mounted, that is, it is not present, the traction element 102 does not encounter any pillar 11a, or any rack 11c as previously discussed, which counterbalances the traction force generated by the driver element 107. In in this case, the traction element 102 moves toward the sustaining element 103 leaving the position of maximum opening and causing the drive of the command element 108 which, consequently, will open an electrical safety contact.

The command element 108 is configured in such a way as to close an electrical safety contact between the motor and its power supply when the traction element 102 is in its position of maximum opening. Conversely, the command element 108 is configured in such a way as to open such electrical safety contact as soon as the traction element 102 leaves its position of maximum opening.

Therefore, when the electrical safety contact is open due to a movement of the traction element 102, for example as soon as the traction element 102 leaves the position of maximum opening, the motor no longer receives power supply and it is locked, without allowing the lifting apparatus 12 to continue its travel.

In other words, when the second module 11f is properly attached to the first module 11e, the traction element 102 does not move from its position of maximum opening and the motor continues to be powered and to move the lifting apparatus 12 along the bearing column 11.

On the contrary, when the upper module 11f is attached incorrectly, that is, loosely, or it is not attached to the lower module 11e with attachment means, or simply the second module 11f is not present, the force generated by the driver element 107 is not counterbalanced. This causes the traction element 102 to move from its position of maximum opening, dragging the upper module 11f with it, when this is present but incorrectly mounted.

In this case, the command element 108 opens the electrical safety contact and does not allow the motor to be powered, therefore the lifting apparatus 12 is immediately locked. This prevents the lifting apparatus 12, in particular the motor element 12a, from loading its weight on the incorrectly attached module 11f.

The person of skill in the art will understand that the same movement of the traction element 102 occurs if the upper module 11f is missing. In this case, the safety device 100 acts as a device for verifying the presence of a module 11d above the module on which the lifting apparatus 12 is located.

The advantage of this solution is that if an operator forgets to attach a module 11d of the bearing column 11 or attaches it incorrectly, for example he does not tighten the attachment systems corresponding to the at least one pillar 11a located in a distal position with respect to the operator himself, the safety device 100 prevents the lifting apparatus 12 from traveling on the incorrectly attached module, thus preventing the possibility that the module 11d itself uncouples, causing the lifting apparatus 12 to fall.

Another advantage is providing a device for verifying the presence of the second module 11f mounted above the first module 11e on which the lifting apparatus 12 is located.

As already stated, each module of the bearing column 11 has a plurality of pillars 11a. At the ends of each module and in correspondence with each pillar 11a there is at least one attachment mean that allows to make the pillar 11a integral with the associated pillar of the module 11d below.

When the lifting system 10 is mounted and when the column 11 has a polygonal section, at least one pillar 11a of the plurality of pillars 11a will be in a distal position with respect to the lifting apparatus 12.

When the at least one attachment mean associated with the distal pillar 11a is not attached or is not attached correctly, the effect of the traction carried out by the traction element 102 is to create a bending moment on the module 11d which generates a rotation of the module 11d around an axis defined by the remaining pillars 11a of the module which are attached correctly.

The bending moment is given by the vector product of the arm, being the distance between the point of application of the force by the traction element 102 and the upper end of the module 11d below, and of the traction force generated by the driver element 107.

The bending moment has to overcome a reaction stabilizing moment generated by the weight force in order to manage to move the module 11d. It is always possible, based on considerations on the weight of the module, on the point of application of the force by the traction element 102, and on the module of the force generated by the driver element 107, to generate a bending moment that allows to overturn the module 11d.

When the bending moment generated by the traction force of the traction element 102 overcomes the reaction stabilizing moment generated by the weight force, the module 11d to which the traction force of the traction element 102 is applied overturns toward the lifting apparatus 12.

In particular, when the screws are not present, the weight of the column counteracts an overturning moment due to the action of the traction element 102, whereas when the screws are present, the traction element 102 exerts a bending moment on the corresponding module 11d.

The person of skill in the art will understand that the same principle is valid with columns that have only two pillars.

In its movement, the overturned module 11d meets the upper end of the sustaining element 103 and ends its motion.

Optionally, in order to prevent the overturned module 11d from tilting too much with respect to the vertical, the safety device 100 can comprise a first locking element 104 which protrudes from the upper end of the sustaining element 103 and which is configured to intercept the overturned module 11d in order to contain the rotation thereof.

According to another option, the safety device 100 comprises a second locking element 105 in correspondence with the lower end of the sustaining element 103 and configured to be disposed behind the at least one pillar 11a proximal with respect to the position of the lifting apparatus 12, when the lifting apparatus 12 is mounted on the bearing column 11.

The advantage of a safety device 100 comprising at least one of either the first locking element 104 or the second locking element 105 is to prevent the module 11d incorrectly attached, or not attached, to the module 11d below from overturning and falling, causing damage to people and/or objects on the ground or to the containing element 12b of the lifting apparatus 12.

With reference to FIG. 4, the safety device 100 can comprise two safety elements 100′ disposed at the ends of one or more connection elements 110. The safety elements 100′ are the same as the safety element 100′ described in relation to FIGS. 2 and 3, to which we refer for reasons of brevity.

The two safety elements 100′ are configured to be mounted at the ends of the support element 101 that has a size comparable to the size of a front section of the bearing column 11.

The two safety elements 100′ are mounted in a specular manner with respect to each other and are configured to act simultaneously on two pillars 11a of the bearing column 11 which are located in a proximal position with respect to the lifting apparatus 12.

In this case, the safety device 100 can comprise two first locking elements 104, each configured to intercept a respective pillar 11a of one module 11d when this is overturned by the traction force exerted by the traction element 102. For example, each first locking element 104 is located substantially in front of a respective contact protrusion 102a. The safety device 100 can also comprise two second locking elements 105, each located and configured in order to abut a respective pillar 11a. For example, each second locking element 105 is located below a respective contact protrusion 102a and advantageously comprises a recess 105′ configured to engage with a pillar 11a, increasing its stability.

As already described, the lifting apparatus 12 can be an elevator or a goods hoist or a platform, or any mean that allows to move a containing element 12b, such as a basket, a cabin or a platform, along the bearing column 11.

According to another example of the invention, the lifting system 10 comprises a lifting apparatus 12 being a basket or a platform mounted on at least two bearing columns 11 located at a determinate distance from each other.

Each of the at least two bearing columns 11 comprises at least one rack 11c in correspondence with one of the modules 11d.

The lifting apparatus 12 comprises a motor element 12a associated with each bearing column 11 which comprises a motor and a pinion which collaborates with the rack 11c associated with the corresponding bearing column 11. Furthermore, the lifting apparatus 12 comprises a safety device 100 as in any previous example associated with each bearing column 11.

We refer to the previous paragraphs for the detailed description of the bearing column 11, of the lifting apparatus 12 and of the safety device 100.

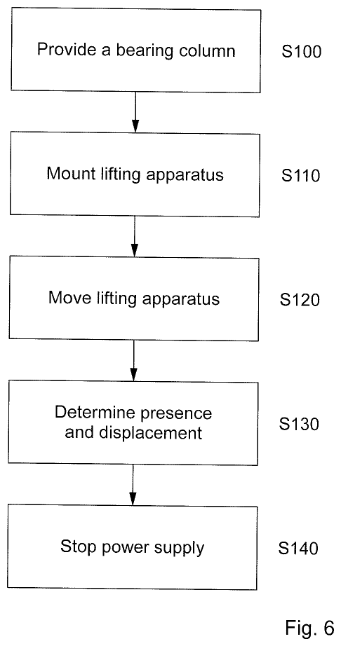

With reference to FIG. 6, a safety control method of a lifting system 10 comprises the following steps.

In a first step S100, the bearing column 11 comprising a plurality of modules 11d is supplied.

In a second step S110, the lifting apparatus 12 comprising the safety device 100 is mounted on a first module 11e of the bearing column 11, in such a way that a proximal pillar 11 a of the bearing column 11 is in an intermediate position between the contact protrusion 102a and the sustaining element 103 of the at least one safety element 100′ so that the at least one traction element 102 exerts a traction force on the column 11.

Starting from when the lifting apparatus 12 is mounted on the first module 11e of the bearing column 11, the safety device 100 acts on the first module 11e exerting on it a traction force generated by the driver element 107 and applied by the traction element 102, by means of the contact protrusion 102a, on a pillar 11a. This traction force is exerted continuously on the pillar 11a and, therefore, on the bearing column 11, once the lifting apparatus 12 is mounted on the bearing column 11.

When the lifting apparatus 12 is mounted on the first module 11e, a pillar 11a is located in an intermediate position between the contact protrusion 102a and the sustaining element 103, in such a way that the sliding surface 102a′ is always in contact with the pillar 11a. The traction element 102 is located in the position of maximum opening, defined previously.

In a third step S120, the lifting apparatus 12 is moved in such a way as to make it rise on the bearing column 11. During the motion, the traction element 102 will reach a higher level with respect to the highest end of the first module 11e.

In a fourth step S130, when the traction element 102 reaches a higher level with respect to the highest end of the first module 11e, the safety device 100 determines whether the second module 11f is present and if it moves due to the traction force exerted by the traction element 102.

In a fifth step S140, the safety device 100 blocks the ascent of the lifting apparatus 12 if it is determined that the second module 11f is not present, or if it is determined that the second module 11f moves due to the traction force exerted by the traction element 102.

If the second module 11f is not present, the traction element 102a moves toward the sustaining element 103 under the force exerted by the driver element 107.

If the second module 11f is present, the traction element 102a exerts a traction force generated by the driver element 107 on a pillar 11a of the second module 11f.

The safety device 100 allows the ascent of the lifting apparatus 12 from the first module 11e to the second module 11f if it is determined that the second module 11f is present and, if present, if it does not move due to the traction force exerted by the traction element 102.

The determination S130 of the presence and movement of the second module 11f is obtained by means of the command element 108 connected with the traction element 102.

As already stated, the traction element 102 continues to exert a traction force on the bearing column 11 generated by the driver element 107. If the module 11d of the bearing column 11 on which the traction element 102 exerts a force is correctly made integral with a module 11d below, the module 11d on which the force is exerted does not move from its position.

On the other hand, if the module 11d of the bearing column 11 on which the traction element 102 exerts a force is not correctly made integral or is not completely made integral with a module 11d below, the module 11d on which the force is exerted moves from its position. This causes the command element 108 to detect a displacement of the bearing column 11 and to open the electrical safety contact with which it is associated, causing the movement of the lifting apparatus 12 to stop.

The same happens when the second module 11f is not present. In this case, the traction element 102 moves toward the sustaining element 103 and the command element 108 detects a displacement of the traction element 102 and opens the electrical safety contact with which it is associated, causing the movement of the lifting apparatus 12 to stop.

In the case shown in FIG. 5, the module 11d that moves due to the traction force is the second module 11f, and the module 11d below corresponds to the first module 11e.

As soon as the traction element 102 leaves the position of maximum opening, the command element 108 determines a displacement of the second module 11f and causes the locking of the motor element 12a, as explained in detail above.

It will be clear to the person of skill in the art that this method is applicable in each lifting system 10 described in relation to the previous examples.

It will also be clear to the person of skill in the art that this same method can be used with a traction element 102a that engages a rack 11c and that exerts a traction force thereon. For the description of this example of the invention, please refer to the description of the safety device 100, of the lifting apparatus 12 and of the lifting system 10 previously provided.

If the lifting system 10 comprised a plurality of safety elements 100′, when at least one command element 108 of a safety element 100′ determines that there has been a displacement of the second module 11f, or it determines the absence of the second module 11f, the method provides to lock the motor of each motor element 12a of the lifting apparatus 12.

In other words, each command element 108 manages the opening and closing of an electrical safety contact according to what described above. An actual electrical safety contact associated with the plurality of command elements 108 is defined by a logical AND operator of the various electrical contacts associated with each command element 108. The value TRUE is associated with a closed electrical safety contact, while the value FALSE is associated with an open electrical safety contact. Therefore, the actual electrical safety contact associated with the plurality of command elements 108 is closed if and only if each electrical safety contact associated with each command element 108 is closed. Otherwise, when at least one electrical safety contact is open, the effective electrical safety contact associated with the plurality of command elements 108 is open.

Stated again in other words, if each command element 108 allows the passage of a current through an electrical safety contact, the command elements 108 of the plurality of command elements are connected in series with each other so as to implement the logic described above.

The fact that the lifting apparatus 12 is locked when at least one command element 108 determines that the second module 11f has moved or is not present, provides additional safety to the lifting system 10.

In the following claims, the sole purpose of the references in brackets is to facilitate reading and they must not be considered as restrictive factors with regard to the field of protection claimed in the specific claims.

1. A safety device comprising:
a support element;
at least one safety element integral with the support element, wherein the at least one safety element comprises a sustaining element, a traction element mechanically connected to the sustaining element in such a way as to allow a movement of the traction element, and a command element configured to open an electrical safety contact when the traction element moves with respect to a predetermined position; and
a driver element with one end connected to the traction element and configured to exert a traction force on the traction element directed toward the sustaining element.

2. The safety device of claim 1, wherein another end of the driver element is connected to the sustaining element.

3. The safety device of claim 1, wherein the traction element comprises, at one end thereof distal with respect to the sustaining element, a contact protrusion configured to transmit the traction force generated by the driver element and having a sliding surface facing toward the sustaining element.

4. The safety device of claim 1, further comprising a first locking element which protrudes from an upper end of the sustaining element.

5. The safety device of claim 4, further comprising a second locking element in correspondence with a lower end of the sustaining element.

6. The safety device of claim 1, wherein the at least one safety element comprises two of the safety element having two traction elements configured to exert a traction force on two different points of a bearing column.

7. The safety device of claim 6, wherein the two traction elements are reciprocally distanced so as to each exert a traction force on a respective pillar of a same module of the bearing column.

8. A lifting apparatus, comprising:
a motor element comprising at least one electric motor and a pinion driven by the electric motor and configured to couple to a rack;
a containing element configured to contain people and/or objects and connected to the motor element; and
the safety device of claim 1.

9. The lifting apparatus of claim 8, wherein the containing element is selected from a group consisting of a basket, a cabin, and a platform.

10. A lifting system comprising:
at least one substantially vertical bearing column comprising a plurality of modules, wherein each of the modules comprises at least two pillars and a rack, wherein the modules stack such that each pillar of each module completely overlaps along the vertical with an associated pillar of the module below, and wherein the rack associated with each module completely overlaps along the vertical with the rack of the module below; and
the lifting apparatus of claim 8,
wherein the pinion of the motor element couples to the rack in order to allow the movement of the lifting apparatus, and
wherein a sliding surface of the traction element is in contact with a pillar or with a rack which is located in an intermediate position between the sliding surface and the sustaining element of the safety device, in such a way as to allow the traction element to exert a constant traction on the module.

11. The lifting system of claim 10, wherein the command element defines an electrical safety contact which allows an electrical connection between the electric motor of the motor element and an electric power supply.

12. The lifting system of claim 11, wherein the command element is configured to open the electrical safety contact when the command element detects a displacement of the traction element, thereby disconnecting the electric power supply and the electric motor.

13. The lifting system of claim 10, further comprising a plurality of the vertical bearing columns a plurality of the safety elements, wherein each safety element is associated with one column of the plurality of vertical bearing columns.

14. The lifting system of claim 13, wherein, when the command element of at least one column of the plurality of vertical bearing columns detects a displacement of the traction element, the lifting system is configured to stop the electric power supply of the electric motor.

15. A safety control method of the lifting system of claim 10, the method comprising:
supplying at least one bearing column, each bearing column comprising at least one first module;
mounting the lifting apparatus on the first module;
moving the lifting apparatus until the at least one traction element goes beyond an upper end of the first module;
determining, via the command element, whether a second module is mounted on the first module and, if the second module is mounted, whether the second module moves under the action of the traction force exerted by the traction element; and
stopping, via the command element, the power supply of the electric motor of the lifting apparatus when the second module is not present or, if the second module is present, when the second module moves under the action of the traction element.
